(19) United States
(12) Patent Application Publication
(10) Pub. No.: US 2026/0242530 A1
(43) Pub. Date: Aug. 20, 2026

(54) CLOSED-CELL WATER-BLOWN RIGID POLYURETHANE FOAMS AND METHODS FOR THEIR PRODUCTION

(71) Applicant: COVESTRO LLC, Pittsburgh, PA (US)

(72) Inventors: Brandon W. PARKS, McKees Rocks, PA (US); Rick L ADKINS, Pittsburgh, PA (US)

(21) Appl. No.: 19/129,871

(22) PCT Filed: Nov. 10, 2023
(86) PCT No.: PCT/US2023/079361

§ 371 Date: May 14, 2025

Related U.S. Application Data
(60) Provisional application No. 63/430,736, filed on Dec. 7, 2022.

(51) Int. Cl. C08G 18/48; C08G 18/08; C08G 18/18; C08G 101/00; C08J 9/00; C08J 9/08; C08J 9/12

(52) U.S. Cl. CPC C08G 18/4829; C08G 18/0838; C08G 18/1808; C08G 18/1816; C08G 18/1875; C08G 18/4816; C08G 18/4879; C08G 18/4883; C08J 9/0038; C08J 9/08; C08J 9/125; C08G 2101/00; C08G 2110/0025; C08G 2110/0083; C08J 2201/022; C08J 2203/02; C08J 2203/10; C08J 2205/052; C08J 2375/08

(57) ABSTRACT

Closed-cell, water-blown, rigid polyurethane foams. The foams are a reaction product of a foam-forming reaction mixture that includes: (a) a polyisocyanate; (b) a polyol composition; (c) a catalyst; and (d) a blowing agent composition. The polyol composition includes at least 30% by weight, based on the total weight of the polyol composition, of a polymer polyol having an OH number of greater than 260 mg KOH/g. The polymer polyol includes a dispersion of polymer particles in a base polyether polyol having a functionality of 2 to 6, an OH number of at least 300 mg KOH/g, and no more than 20% by weight of ethylene oxide units, based on the molecular weight of the polyether polyol. The polymer particles are the reaction product of an ethylenically unsaturated composition consisting essentially of styrene and acrylonitrile. The blowing agent composition includes water in an amount of at least 80% by weight, based on the total weight of the blowing agent composition.

### FIELD

This specification pertains generally to closed-cell water-blown rigid polyurethane foams that may be used as a thermal insulation medium in the construction of, for example, entry and garage doors. More particularly, the inventions of this specification relate to the use of polymer polyols (“PMPOs”) in the production of such foams.

### BACKGROUND

Rigid polyurethane foams are used in numerous applications. They are produced by reacting an appropriate polyisocyanate and an isocyanate-reactive compound, usually a polyol, in the presence of a blowing agent. One use of such foams is as a thermal insulation medium in the construction of entry and garage doors. The thermal insulating properties of closed-cell rigid foams are dependent upon a number of factors, including the average cell size and the thermal conductivity of the contents of the cells.

The thermal conductivity of the contents of the cells depends upon the blowing agent used. Fluorocarbons have historically often been used because of their low thermal conductivity. However, fluorocarbons, including chlorofluorocarbons (“CFCs”), hydrofluorocarbons (“HFCs”) and hydroclorofluorocarbons (“HCFCs”), are greenhouse gases that are being phased out of use. Halogenated olefins, such as hydrofluoroolefins (“HFO”) and hydrochlorofluoroolefins (“HCFOs”), are potential environmentally-friendly alternatives for such fluorocarbons, but they can be costly and they may react with certain catalysts often used in the reaction mixture, resulting in poor foam quality if a pre-mix composition containing the blowing agent and catalyst is aged prior to use.

In some cases, a hydrocarbon blowing agent is employed. Hydrocarbons are often less expensive than CFCs, HFCs, HCFCs, HFOs, and HCFOs and they can be more environmentally friendly than CFCs, HFCs, and HCFCs. These hydrocarbons are, however, highly flammable and volatile, thereby raising both safety concerns and concerns about the emission of volatile organic compounds (VOCs).

As a result, effort has been directed to using water as the sole or at least primary blowing agent in the production of some rigid polyurethane foams. One drawback to using water as the sole or primary blowing agent for producing closed-cell rigid polyurethane foams, however, is that carbon dioxide, which is formed via reaction of water with isocyanate and which makes up the gaseous content of the closed-cells in water-blown foams, has a higher thermal conductivity than the above-mentioned fluorocarbons and hydrocarbons, thereby resulting in closed-cell foams having poorer thermal insulating properties.

Thermal efficiency, often evaluated with respect to a low thermal conductivity, or “K-factor”, is a critically important feature of rigid polyurethane foam insulation. In the case of entry and garage doors, for example, even seemingly relatively small reductions in K-factor, such as on the order of just a few percent, can translate into very significant improvements in energy efficiency. Alternatively, foam thickness or foam density could be reduced while achieving similar insulation properties.

Therefore, water-blown closed-cell rigid polyurethane foams exhibiting reduced thermal conductivity would be highly desirable. Reducing the thermal conductivity of the foam cannot, however, come at the price of significantly deteriorating other important properties, including physical properties of the foam (such as dimensional stability or compressive strength) or processing characteristics (such as flow, reactivity and de-mold characteristics).

The inventions described in this specification were made in view of the foregoing.

### SUMMARY

In certain respects, this disclosure is directed to rigid polyurethane foams. These rigid polyurethane foams comprise the reaction product of a foam-forming reaction mixture comprising: (a) a polyisocyanate; (b) a polyol composition comprising at least 30% by weight, based on the total weight of the polyol composition, of a polymer polyol having an OH number of greater than 260 mg KOH/g, wherein the polymer polyol comprises a dispersion of polymer particles in a base polyether polyol having a functionality of 2 to 6, an OH number of at least 300 mg KOH/g, and no more than 20% by weight of ethylene oxide units, based on the molecular weight of the polyether polyol, wherein the polymer particles are the reaction product of an ethylenically unsaturated composition consisting essentially of styrene and acrylonitrile; (c) a catalyst; and (d) a blowing agent composition comprising water in an amount of at least 80% by weight, based on the total weight of the blowing agent composition. The rigid polyurethane foam has a closed-cell content of more than 80%, measured according to ASTM D6226-15.

This specification is also directed to, among other things, methods for making such rigid polyurethane foams and polyurethane foam-forming reaction mixtures suitable for producing such closed-cell, rigid polyurethane foams.

### DETAILED DESCRIPTION

Various implementations are described and illustrated in this specification to provide an overall understanding of the structure, function, properties, and use of the disclosed inventions. It is understood that the various implementations described and illustrated in this specification are non-limiting and non-exhaustive. Thus, the invention is not limited by the description of the various non-limiting and non-exhaustive implementations disclosed in this specification. The features and characteristics described in connection with various implementations may be combined with the features and characteristics of other implementations. Such modifications and variations are intended to be included within the scope of this specification. As such, the claims may be amended to recite any features or characteristics expressly or inherently described in, or otherwise expressly or inherently supported by, this specification. Further, Applicant(s) reserve the right to amend the claims to affirmatively disclaim features or characteristics that may be present in the prior art. Therefore, any such amendments comply with the requirements of 35 U.S.C. § 112 and 35 U.S.C. § 132 (a). The various implementations disclosed and described in this specification can comprise, consist of, or consist essentially of the features and characteristics as variously described herein.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant(s) reserves the right to amend this specification to expressly recite any subject matter, or portion thereof, incorporated by reference herein.

In this specification, other than where otherwise indicated, all numerical parameters are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the doctrine of equivalents, each numerical parameter described in this specification should at least be construed in light of the number of reported significant digits and by applying ordinary rounding techniques.

Also, any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example. 2.4 to 7.6. Any maximum numerical limitation recited in this specification is intended to include all lower numerical limitations subsumed therein and any minimum numerical limitation recited in this specification is intended to include all higher numerical limitations subsumed therein. Accordingly, Applicant(s) reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. § 112 and 35 U.S.C. § 132 (a).

The grammatical articles “one”. “a”. “an”, and “the”, as used in this specification, are intended to include “at least one” or “one or more”, unless otherwise indicated. Thus, the articles are used in this specification to refer to one or more than one (i.e., to “at least one”) of the grammatical objects of the article. By way of example, “a component” means one or more components, and thus, possibly, more than one component is contemplated and may be employed or used in an implementation of the described implementations. Further, the use of a singular noun includes the plural, and the use of a plural noun includes the singular, unless the context of the usage requires otherwise.

As used herein, the term “functionality” refers to the average number of reactive hydroxyl groups, —OH, present per molecule of the —OH functional material that is being described. The term “hydroxyl number”, as used herein, refers to the number of reactive hydroxyl groups available for reaction, and is expressed as the number of milligrams of potassium hydroxide equivalent to the hydroxyl content of one gram of the polyol, measured according to ASTM D4274-16. The term “equivalent weight” refers to the weight of a compound divided by its valence. For a polyol, the equivalent weight is the weight of the polyol that will combine with an isocyanate group, and may be calculated by dividing the molecular weight of the polyol by its functionality. The equivalent weight of a polyol may also be calculated by dividing 56,100 by the hydroxyl number of the polyol-Equivalent Weight (g/cq)=(56.1×1000)/OH number.

Equivalent weights and molecular weights given herein in Daltons (Da) are number average equivalent weights and number average molecular weights respectively, as determined, unless indicated otherwise, by gel-permeation chromatography (GPC) using a method based on DIN 55672-1, employing chloroform as the eluent with a mixed bed column (Agilent PL Gel; SDVB; 3 micron Pore diameter: 1×Mixed-E+5 micron Pore diameter: 2×Mixed-D), refractive index (RI) detection and calibrated with polyethylene glycol as the standard.

As indicated, certain implementations of the present specification relate to the production of rigid foams. A rigid foam is characterized as having a ratio of compressive strength to tensile strength of at least 0.5:1, elongation of less than 10%, as well as a low recovery rate from distortion and a low elastic limit, as described in in “Polyurethanes: Chemistry and Technology, Part II Technology,” J. H. Saunders & K. C. Frisch, Interscience Publishers. 1964, page 239.

In addition, the rigid foams of this specification are closed-cell rigid foams. As will be appreciated, for thermally insulating foams, it is desirable that the foam have a high content of closed-cells so that the blowing agent primarily or exclusively retained within the cells. Specifically, the closed-cell foams of this specification have a closed-cell content of more than 80 percent, more than 85 percent, or more than 88 percent closed-cell content as measured according to ASTM D6226-15.

Therefore, the foam-forming reaction mixtures described herein are substantially free of any component that acts as a cell-opener. For example, as is known. certain types of polymer polyols different from the polymer polyols described herein can act as cell openers (due to polymer particles potentially being incorporated into the cell windows, making them easier to fracture), as can certain polyolefins, such as polybutene and polybutadiene rubbers, and polyalkylene oxides having a high proportion of ethylene oxide (such as 50 to 100 weight percent ethylene oxide, based on total weight of alkylene oxide), such as those having an average hydroxyl functionality of 0 to 3 and an average molecular weight of 200 to 3500. Other known cell-openers include certain silicone-based polymers (such as Niax™ Silicones L-620, L-626, and L-6164 from Momentive), waxes, fluorinated polymers, such as Teflon, paraffin oils, long-chain fatty acids, and finely divided solids, such as calcium stearate, magnesium stearate, and zinc stearate. The foam-forming reaction mixtures described herein are, therefore, free of such materials or, if they are present, they are not present in an amount sufficient to result in a foam that does not have a closed-cell content of more than 80%, as described above.

The rigid foams of this specification are the reaction product of a foam-forming reaction mixture that includes: (a) a polyisocyanate; and (b) a polyol composition. As used herein, the term “polyisocyanate” encompasses diisocyanates as well as higher functionality polyisocyanates.

Any of the known organic isocyanates, modified isocyanates or isocyanate-terminated prepolymers made from any of the known organic isocyanates may be used. Suitable organic isocyanates include aromatic, aliphatic, and cycloaliphatic polyisocyanates and combinations thereof. Useful isocyanates include: diisocyanates such as m-phenylene diisocyanate, p-phenylene diisocyanate, 2,4-toluene diisocyanate, 2,6-toluene diisocyanate, 1,6-hexamethylene diisocyanate, 1,4-hexamethylene diisocyanate, 1,3-cyclohexane diisocyanate, 1,4-cyclo-hexane diisocyanate, isomers of hexahydro-toluene diisocyanate, isophorone diisocyanate, dicyclo-hexylmethane diisocyanate, 1,5-naphthylene diisocyanate, 4,4′-diphenylmethane diisocyanate, 2,4′-diphenylmethane diisocyanate, 4,4′-biphenylene diisocyanate, 3,3′-dimethoxy-4,4′-biphenylene diisocyanate and 3,3′-dimethyl-diphenyl-propane-4,4′-diisocyanate; triisocyanates, such as 2,4,6-toluene triisocyanate; and higher functionality polyisocyanates, such as 4.4′-dimethyl-diphenylmethane-2,2′,5,5′-tetraisocyanate and the polymethylene polyphenyl-polyisocyanates.

Undistilled or crude polyisocyanates may also be used. Crude toluene diisocyanate obtained by phosgenating a mixture of toluene diamines and the crude diphenylmethane diisocyanate obtained by phosgenating crude diphenylmethanediamine (polymeric MDI) are examples of suitable crude polyisocyanates.

Modified isocyanates are obtained by chemical reaction of diisocyanates and/or polyisocyanates. Useful modified isocyanates include, but are not limited to, those containing ester groups, urea groups, biuret groups, allophanate groups, carbodiimide groups, isocyanurate groups, uretdione groups and/or urethane groups. Examples of modified isocyanates include prepolymers containing NCO groups and having an NCO content of 25 to 35 weight percent, such as 29 to 34 weight percent, such as those based on a polyether polyol or polyester polyol and diphenylmethane diisocyanate.

In certain implementations, the polyisocyanate comprises a methylene-bridged polyphenyl polyisocyanate and/or a prepolymer of methylene-bridged polyphenyl polyisocyanate having an average functionality of from 1.8 to 3.5, such as from 2.0 to 3.1, isocyanate moieties per molecule and an NCO content of from 25 to 32 weight percent.

The foam-forming reaction mixture used to produce the rigid polyurethane foams of this specification comprise a polyol composition that comprises at least 30% by weight, based on the total weight of the polyol composition, of a polymer polyol having an OH number of greater than 260 mg KOH/g, wherein the polymer polyol comprises a dispersion of polymer particles in a polyether polyol having a functionality of 2 to 6, an OH number of at least 300 mg KOH/g, and no more than 20% by weight of ethylene oxide units, based on the molecular weight of the polyether polyol. In some implementations, the foregoing polymer polyol is present in an amount of at least 35% by weight, at least 40% by weight, or, in some cases, at least 50% by weight, based on the total weight of the polyol composition. In some of these implementations, the polymer polyol is also present in an amount of no more than 80% by weight, such as no more than 70% by weight, or, in some cases, no more than 60% by weight, based on the total weight of the polyol composition.

The foregoing polymer polyol is a dispersion of polymer particles in a polyether polyol. In some embodiments, the polymer polyol has a solids content, i.e., content of polymer particles, of 20% to 65% by weight, such as 20% to 60% by weight, or 20% to 50% by weight, based on the total weight of the polymer polyol.

The polymer particles comprise a polymer comprising the free radical polymerization reaction product of an ethylenically unsaturated composition. More particularly, in some of these embodiments, the polymer polyol comprises a reaction product of a reaction mixture comprising: (a) a base polyether polyol; (b) an ethylenically unsaturated composition, (c) optionally a preformed stabilizer, and (d) a free radical initiator.

Suitable base polyether polyols include, for example, polyether polyols having a functionality of 2 to 6, such as 2 to 5 or 3 to 5, and an OH number of at least 300 mg KOH/g, such as 300 to 1000 mg KOH/g, 300 to 800 mg KOH/g. 300 to 600 mg KOH/g, or, in some cases, 300 to 500 mg KOH/g or 300 to 400 mg KOH/g.

Specific examples of suitable base polyether polyols include polyoxyethylene glycols, polyoxyethylene triols, polyoxyethylene tetrols and higher functionality polyoxyethylene polyols, polyoxypropylene glycols, polyoxypropylene triols, polyoxypropylene tetrols and higher functionality polypropylene polyols, mixtures thereof. When mixtures are used, the ethylene oxide and propylene oxide may be added simultaneously or sequentially to provide internal blocks, terminal blocks or random distribution of the oxyethylene groups and/or oxypropylene groups in the polyether polyol. Suitable starters or initiators for these compounds include, for example, ethylene glycol, propylene glycol, diethylene glycol, dipropylene glycol, tripropylene glycol, trimethylol-propane, glycerol, pentaerythritol, sorbitol, sucrose, ethylenediamine, and/or toluene diamine. The alkoxylation reaction may be catalyzed using any conventional catalyst including, for example, potassium hydroxide (KOH) or a double metal cyanide (DMC) catalyst.

Other suitable polyether polyols for the base polyol include alkylene oxide adducts of non-reducing sugars and sugar derivatives, alkylene oxide adducts of phosphorus and polyphosphorus acids, alkylene oxide adducts of polyphenols, polyols prepared from natural oils such as, for example, castor oil, etc., and alkylene oxide adducts of polyhydroxyalkanes other than those described above.

Illustrative alkylene oxide adducts of polyhydroxyalkanes include, for example, alkylene oxide adducts of 1,3-dihydroxypropane, 1,3-dihydroxybutane, 1,4-dihydroxybutane, 1,4-, 1,5- and 1,6-dihydroxyhexane, 1,2-, 1,3-, 1,4-1,6- and 1,8-dihydroxyoctant, 1,10-dihydroxydecane, glycerol, 1,2,4-trihydroxybutane, 1,2,6-trihydroxyhexane, 1,1,1-trimethyl-olethane, 1,1,1-trimethylolpropane, pentaerythritol, caprolactone, polycaprolactone, xylitol, arabitol, sorbitol, and/or mannitol.

Other polyether polyols which can be employed include the alkylene oxide adducts of non-reducing sugars, wherein the alkoxides have from 2 to 4 carbon atoms. Non-reducing sugars and sugar derivatives include sucrose, alkyl glycosides, such as methyl glycoside and ethyl glucoside, glycol glucosides, such as ethylene glycol glycoside, propylene glycol glucoside, glycerol glucoside, and 1,2,6-hexanetriol glucoside, as well as alkylene oxide adducts of the alkyl glycosides.

Other suitable base polyols include polyphenols, such as the alkylene oxide adducts thereof, wherein the alkylene oxides have from 2 to 4 carbon atoms. Among the polyphenols which are suitable are, for example, bisphenol A, bisphenol F, condensation products of phenol and formaldehyde, novolac resins, condensation products of various phenolic compounds and acrolein, including the 1,1,3-tris(hydroxy-phenyl)propanes, condensation products of various phenolic compounds and glyoxal, glutaraldehyde, and/or other dialdehydes, including the 1,1,2,2-tetrakis(hydroxyphenol)ethanes.

The alkylene oxide adducts of phosphorus and polyphosphorus acid are also suitable base polyols. These include ethylene oxide. 1,2-epoxy-propane, the epoxybutanes, 3-chloro-1,2-epoxypropane as alkylene oxides. Phosphoric acid, phosphorus acid. polyphosphoric acids, such as tripolyphosphoric acid, and the polymetaphosphoric acids are suitable for use herein.

In the polymer polyols described herein, the content of ethylene oxide units in the base polyether polyol is relatively low. Specifically, base polyether polyol comprises, based on the molecular weight of the base polyol, no more than 20% by weight, or, in some cases, no more than 10% by weight or no more than 5% by weight, of ethylene oxide units.

Furthermore, in the polymer polyols described herein, the polymer particles are the reaction product of an ethylenically unsaturated composition consisting essentially of styrene and acrylonitrile. More specifically, in some implementations, styrene and acrylonitrile are used in sufficient amounts such that the weight ratio of styrene to acrylonitrile (S:AN) is within the range of 80:20 to 20:80, such as 75:25 to 25:75, 70:30 to 30:70 or 60:40 to 50:50. As used herein, “consisting essentially of”, when used with reference to the presence of styrene and acrylonitrile in the ethylenically unsaturated composition that produces the polymer particles, means that the ethylenically unsaturated composition is limited to styrene, acrylonitrile and any other ethylenically unsaturated compounds that do not materially affect the basic and novel characteristics of the inventions described in this specification, in which these basic and novel characteristics refer to the ability to produce a water-blown closed-cell rigid polyurethane foams exhibiting reduced thermal conductivity and without any significant deterioration of foam physical properties and processing characteristics. More specifically, in some implementations, styrene and acrylonitrile are present in an amount of at least 90% by weight, at least 95% by weight, at least 98% by weight, or at least 99% by weight, based on the total weight of the ethylenically unsaturated composition.

In fact, it was a surprising discovery that use of polymer polyols of the type described herein, in an amount as described herein, could result in water-blown closed-cell polyurethane foams exhibiting significantly improved thermal insulation properties, as reflected by reduced k-factor, compared to such foams produced using a foam-forming reaction mixture that did not include polymer polyol at all or that utilized a polymer polyol in which the polymer particles were the reaction product of a different ethylenically unsaturated composition, such as a composition comprising 2-hydroxyethyl acrylate and butyl acrylate, while maintaining or even further improving other important physical and processing properties, such as compressive strength, dimensional stability, flow, reactivity and/or de-mold characteristics.

In some implementations, the pre-formed stabilizer used to produce the polymer polyol composition comprises the reaction product of a reaction mixture comprising: (a) a macromer that contains reactive unsaturation, (b) an ethylenically unsaturated compound, (c) a free radical initiator, (d) a polymer control agent; and, in some cases, (e) a diluent.

In some implementations, the macromer utilized to produce the pre-formed stabilizer comprises the reaction product of a reaction mixture comprising: (i) an H-functional starter having a functionality of 2 to 8 and a hydroxyl number of 20 to 50; (ii) from 0.1 to 3% by weight, based on 100% by weight of the sum of components (i), (ii) and (iii). of a hydroxyl-reactive compound that contains reactive unsaturation; and (iii) from 0 to 3% by weight, such as 0.05 to 2.5% by weight, or 0.1 to 1.5% by weight, based on 100% by weight of the sum of components (i), (ii) and (iii), of a diisocyanate.

Suitable preformed stabilizers can be prepared by reacting a combination of components (a), (b), (c) and (d), and optionally, (e), as described above, in a reaction zone maintained at a temperature sufficient to initiate a free radical reaction, and under sufficient pressure to maintain only liquid phases in the reaction zone, for a sufficient period of time to react (a), (b) and (c); and recovering a mixture containing the preformed stabilizer dispersed in the polymer control agent.

Suitable starters for use in preparing the macromer include compounds having a hydroxyl functionality of 2 to 8, such as 3 to 6, and a hydroxyl number of, for example, 20 to 50 mg KOH/g, such as 25 to 40 mg KOH/g. A specific example of a suitable starter is an alkylene oxide adduct of a hydroxyl functional compound, such as ethylene glycol, propylene glycol, diethylene glycol, dipropylene glycol, tripropylene glycol, glycerin, trimethylolpropane, pentaerythritol, sorbitol, ethylenediamine, and toluene diamine, among others, including mixtures of any two or more thereof, in which the alkylene oxide comprises, for example, propylene oxide, ethylene oxide, butylene oxide, or styrene oxide, among others, including mixtures of any two or more thereof. When a mixture of alkylene oxides are used to form the starter, a mixture of propylene oxide and ethylene oxide may be advantageous. Such mixtures may be added simultaneously (i.e. two or more alkylene oxide are added as co-feeds), or sequentially (one alkylene oxide is added first, and then another alkylene oxide is added). It is possible to use a combination of simultaneous and sequential addition of alkylene oxides. In one embodiment, an alkylene oxide such as propylene oxide may be added first, and then a second alkylene oxide such as ethylene oxide added as a cap.

Other examples of suitable starters for preparing the macromer are polyoxyethylene glycols, triols, tetrols and higher functionality polyols, and mixtures thereof, as well as alkylene oxide adducts of non-reducing sugars and sugar derivatives, alkylene oxide adducts of phosphorus and polyphosphorus acids, alkylene oxide adducts of polyphenols, polyols prepared from natural oils such as, for example, castor oil, and alkylene oxide adducts of polyhydroxyalkanes other than those described above. Illustrative alkylene oxide adducts of polyhydroxyalkanes include, for example, alkylene oxide adducts of 1,3-dihydroxypropane, 1,3-dihydroxybutane, 1.4-dihydroxybutane, 1,4-, 1,5- and 1,6-dihydroxyhexane, 1,2-, 1,3-, 1,4-1,6- and 1,8-dihydroxyoctant, 1,10-dihydroxydecane, glycerol, 1,2,4-trihydroxybutane, 1,2,6-trihydroxyhexane, 1,1,1-trimethyl-olethane, 1,1,1-trimethylolpropane, pentaerythritol, caprolactone, polycaprolactone, xylitol, arabitol, sorbitol, and mannitol. Specific examples of alkylene oxide adducts of non-reducing sugars, include those where the alkoxides have from 2 to 4 carbon atoms. Non-reducing sugars and sugar derivatives include sucrose, alkyl glycosides, such as methyl glycoside and ethyl glucoside, glycol glucosides, such as ethylene glycol, glycoside, propylene glycol glucoside, glycerol glucoside, and 1,2,6-hexanetriol glucoside, and alkylene oxide adducts of the alkyl glycosides. Other suitable polyols starters for preparing the macromer include polyphenols, such as alkylene oxide adducts thereof, wherein the alkylene oxides have from 2 to 4 carbon atoms. Suitable polyphenols include, for example, bisphenol A. bisphenol F, condensation products of phenol and formaldehyde, the novolac resins, condensation products of various phenolic compounds and acrolein, including the 1,1,3-tris(hydroxy-phenyl)propanes, condensation products of various phenolic compounds and glyoxal, glutaraldehyde, other dialdehydes, including the 1,1,2,2-tetrakis(hydroxyphenol)ethanes.

In some implementations, the starter used to prepare the macromer has a functionality of from 3 to 6 and a hydroxyl number of from 25 to 40 mg KOH/g, and is prepared by reacting a starter such as glycerin, trimethylolpropane. pentaerythritol, dipentaerythritol, sorbitol, mannitol, or a mixture of any two or more thereof, with an alkylene oxide comprising at least one of propylene oxide and/or ethylene oxide. In some of these embodiments, ethylene oxide is utilized in an amount of 1 to 40% by weight, such as 5 to 30% by weight or 10 to 25% by weight, based on the total weight of the starter compound. In some embodiments, all or a portion of the ethylene oxide is added as a cap on the end of the starter compound. Suitable amounts of ethylene oxide to be added as a cap range from, for example, 1 to 40% by weight, such as 3 to 30% by weight or 5 to 25% by weight, based on the total weight of starter.

In some implementations, however, the macromer is not a polar polymer, i.e., it is not rich in ethylene oxide, nor does it have polar functional groups incorporated therein.

As indicated earlier, in some implementations, the reaction mixture used to produce the macromer utilized to produce the pre-formed stabilizer also comprises a hydroxyl-reactive compound that contains reactive unsaturation. Suitable such compounds include, for example, methyl methacrylate, ethyl methacrylate, maleic anhydride, isopropenyl dimethyl benzyl isocyanate, 2-isocyanatoethyl methacrylate, adducts of isophorone diisocyanate and 2-hydroxyethyl methacrylate, and adducts of toluenediisocyanate and 2-hydroxypropyl acrylate, among others, including mixtures of any two or more thereof.

As also indicated earlier, in some implementations, the reaction mixture used to produce the macromer utilized to produce the pre-formed stabilizer may also comprise a diisocyanate. Suitable diisocyanates include various isomers of diphenylmethane diisocyanate and isomeric mixtures of diphenylmethane diisocyanate, such as, for example, mixtures of 2,4′-diphenylmethane diisocyanate, 4,4′-diphenylmethane diisocyanate and/or 2.2′-diphenyl-methane diisocyanate. Other suitable isocyanates include toluenediisocyanate, isophoronediisocyanate, hexamethylenediisocyanate, and 4,4′-methylenebis(cyclohexyl isocyanate), among others, includes mixtures of any two or more thereof.

In certain implementations, the macromer is used in an amount of 10 to 40% by weight, such as 15 to 35% by weight, based on the total weight of the reaction mixture used to produce the pre-formed stabilizer.

As previously mentioned, in some implementations, the reaction mixture used to form the pre-formed stabilizer used to produce the polymer polyol also comprises an ethylenically unsaturated compound. Suitable such ethylenically unsaturated compounds are aliphatic conjugated dienes, such as butadiene and isoprene; monovinylidene aromatic monomers, such as styrene, α-methylstyrene, (t-butyl) styrene, chlorostyrene, cyanostyrene and bromostyrene; α,β-ethylenically unsaturated carboxylic acids and esters thereof, such as acrylic acid, methacrylic acid, methyl methacrylate, ethyl acrylate, 2-hydroxyethyl acrylate, butyl acrylate, itaconic acid, and maleic anhydride; α,β-ethylenically unsaturated nitriles and amides, such as acrylonitrile, methacrylonitrile, acrylamide, methacrylamide. N,N-dimethyl acrylamide, and N-dimethylaminomethyl) acryl-amide; vinyl esters, such as vinyl acetate; vinyl ethers; vinyl ketones; vinyl and vinylidene halides, as well as a wide variety of other ethylenically unsaturated materials which are copolymerizable with the macromer, including mixtures of any two or more thereof.

In some implementations, the reaction mixture used to form the pre-formed stabilizer used to produce the polymer polyol comprises an ethylenically unsaturated monomer comprising a mixture of acrylonitrile and at least one other ethylenically unsaturated comonomer which is copolymerizable with acrylonitrile, such as, for example, styrene and its derivatives, acrylates, methacrylates, such as methyl methacrylate, vinylidene chloride, among others, as well as mixtures of any two or more thereof. When using acrylonitrile with a comonomer, it is sometimes desirable that a minimum of 5 to 15% by weight acrylonitrile be maintained. One specific ethylenically unsaturated monomer mixture suitable for making the preformed stabilizer comprises mixtures of acrylonitrile and styrene in which, for example, acrylonitrile is used in an amount of 20 to 80% by weight, such as 30 to 70% by weight, based on the total weight of the monomer mixture, and styrene is used in an amount of 80 to 20% by weight, such as 70 to 30% by weight percent, based on the total weight of the monomer mixture.

In certain implementations, the ethylenically unsaturated compound is used in an amount of 10 to 30% by weight, such as 15 to 25% by weight, based on the total weight of the reaction mixture used to produce the pre-formed stabilizer.

The reaction mixture used to produce the pre-formed stabilizer, in certain implementations, also include a free radical initiator. Exemplary suitable free-radical initiators include peroxides, including both alkyl and aryl hydro-peroxides, persulfates, perborates, percarbonates, and azo compounds. Some specific examples include hydrogen peroxide, di(t-butyl)-peroxide, t-butylperoxy diethyl acetate, t-butyl peroctoate, t-butyl peroxy isobutyrate, t-butyl peroxy 3,5,5-trimethyl hexanoate, t-butyl perbenzoate, t-butyl peroxy pivalate, t-amyl peroxy pivalate. t-butyl peroxy-2-ethyl hexanoate, lauroyl peroxide, cumene hydroperoxide, t-butyl hydroperoxide, azobis(isobutyronitrile), and 2,2′-azo bis-(2-methylbutyronitrile). In some cases, the catalyst selected has a half-life that is 25 percent or less of the residence time in the reactor at a given temperature. Representative examples of useful initiators species include t-butyl peroxy-2-ethyl-hexanoate, t-butylperpivalate, t-amyl peroctoate, 2,5-dimethyl-hexane-2,5-di-per-2-ethyl hexoate, t-butylperneodecanoate, and t-butylperbenzoate, as well as azo compounds, such as azobis-isobutyronitrile, 2,2′-azo bis-(2-methylbutyro-nitrile), and mixtures thereof.

In some implementations, the free radical initiator is used in an amount of 0.01 to 2% by weight, such as 0.05 to 1% by weight or 0.05 to 0.3% by weight, based on the total weight of the reaction mixture used to produce the pre-formed stabilizer.

The reaction mixture used to produce the pre-formed stabilizer, in certain implementations, also includes a polymer control agent. Suitable polymer control agents include various mono-ols (i.e. monohydroxy alcohols), aromatic hydrocarbons, and ethers. Specific examples of suitable polymer control agents are alcohols containing at least one carbon atom, such as methanol, ethanol, n-propanol, isopropanol, n-butanol, sec-butanol, t-butanol, n-pentanol, 2-pentanol, 3-pentanol, and the like, and mixtures of any two or more thereof. Other suitable polymer control agents include ethylbenzene and toluene. The polymer control agent can be used in substantially pure form (i.e. as commercially available) or can be recovered in crude form from the polymer polyol production process and reused as-is. For instance, if the polymer control agent is isopropanol, it can be recovered from the polymer polyol process and used at any point in a subsequent product campaign in which the isopropanol is present.

In certain implementations, the polymer control agent is used in an amount of 30 to 80% by weight, such as 40 to 70% by weight, based on the total weight of the reaction mixture used to produce the pre-formed stabilizer.

As previously indicated, the reaction mixture used to produce the pre-formed stabilizer, in certain implementations, may also include a diluent. Suitable diluents include, for example, polyols, hydrocarbons, ethers, and mixtures of any two or more thereof, specific examples of which include, but are not limited to, methanol, isopropanol, toluene, ethylbenzene, polyether polyols, and mixtures of any two or more thereof. In some implementations, the diluent is the same as or equivalent to the polyol used in the formation of precursor used to prepare the preformed stabilizer. In certain implementations, the diluent is used in an amount of 0 to 40% by weight, such as 0 to 20% by weight, or, in some cases, 0 to 10% by weight, based on the total weight of the reaction mixture used to produce the pre-formed stabilizer.

The preformed stabilizer can be produced by a process similar to that of making the polymer polyol. The temperature range is not critical and may vary from, for example, 80° C. to 150° C., such as 115° C. to 125° C. The mixing conditions employed can, for example, be those obtained using a back mixed reactor (e.g.—a stirred flask or stirred autoclave).

As indicated earlier, the reaction mixture used to produce certain implementations of the polymer polyol also comprises a free radical initiator, particularly where the polymer particles are the free radical polymerization reaction product of an ethylenically unsaturated compound. Suitable such free-radical initiators include, for example, any of those described previously with respect to the production of the preformed stabilizer. In certain implementations, the free-radical initiator is present in the reaction mixture used to produce the polymer polyol in an amount of 0.01 to 2% by weight, based on 100% by weight of the final polymer polyol.

In some implementations, the reaction mixture used in preparing the polymer polyol further comprises a chain transfer agent. Examples of suitable chain transfer agents are mercaptans, such as dodecane thiol, ethane thiol, octane thiol, and toluene thiol, halogenated hydrocarbons, such as carbon tetrachloride, carbon tetrabromide, and chloroform, amines, such as diethylamine, and enol-ethers. In some cases, if used, the chain transfer agent is used in an amount of 0.1 to 2% by weight, such as 0.2 to 1% by weight, based on the total weight of the reaction mixture used to produce the polymer polyol.

The polymer polyol can be made using any process (including continuous and semi-batch) and reactor configuration that is known to be suitable to prepare polymer polyols, such as, for example, a two-stage reaction system comprising a continuously-stirred tank reactor (CSTR) fitted with impeller(s) and baffles (first-stage) and a plug-flow reactor (second stage). Furthermore, the reaction system can utilize a wide range of mixing conditions. The reaction system may be characterized by energy inputs of from 0.5 to 350 horsepower per 1000 gallons, such as 2 to 50 horsepower per 1000 gallons on average for the bulk phase volume of each reactor as a particularly useful mixing power input. Mixing can be provided by any combination of impeller(s) and pump-around loop/jet mixing. In addition, the polymer polyols can be prepared from various types and combinations of axially and/or radially/tangentially acting impellers including, but not limited to, 4-pitched-blade, 6-pitched-blade, 4-flat-blade, 6-flat-blade, pitched-blade turbine, flat-blade turbine, Rushton, and Maxflow propeller. For a continuous production process to prepare polymer polyols, a residence time ranging of 20 to 180 minutes for the first reactor may be particularly useful.

In some implementations, the reactants are pumped from feed tanks through an in-line static mixer, and then, through a feed tube into the reactor. It may be particularly useful to prepare a premix of the initiator with part of the polyol stream, as well as of polyol and stabilizer. In general, feed stream temperatures are ambient (i.e. 25° C.). However, if desired, feed streams can be heated prior to mixing and entering the reactor. Another process condition that may be useful is cooling of the feed tube in the reactor. Furthermore, the suitable reaction conditions for polymer polyols in general may be characterized by a reaction temperature in the range of 80 to 200° C. and a pressure in the range of 20 to 80 psig. Typically, the product can then treated in a single or multi staged stripping step to remove volatiles before entering a stage, which can essentially be any combination of filtration and/or product cooling.

In many cases, the polymer polyols are produced by utilizing a low monomer to polyol ratio which is maintained throughout the reaction mixture during the process. This can be achieved by employing conditions that provide rapid conversion of monomer to polymer. In practice, a low monomer to polyol ratio is maintained, in the case of semi-batch and continuous operation, by control of the temperature and mixing conditions and, in the case of semibatch operation, also by slowly adding the monomers to the polyol. The temperature range is not critical and may vary from, for example, 80° C. to 200° C., 100° C. to 140° C., or, in some cases, 115° C. to 125° C.

One suitable continuous process for making polymer polyols as described above comprises (1) providing a heterogenous mixture of the preformed stabilizer and, optionally, liquid diluent, in combination with a polyol, a free radically polymerizable ethylenically unsaturated compound, and a free radical polymerization initiator, (2) in a reaction zone maintained at a temperature sufficient to initiate a free radical reaction, and under sufficient pressure to maintain only liquid phases in the reaction zone, for a period of time sufficient to react at least a major portion of the ethylenically unsaturated compound to form a heterogenous mixture containing the enhanced polymer polyol, unreacted monomers and diluent, and stripping the unreacted monomers and diluent from the enhanced polymer polyol to recover the unreacted monomers and diluent.

In some implementations, the polymer particles (whether individual particles or agglomerates of individual particles) are relatively small in size and, in some cases, have a weight average diameter less than ten microns.

As indicated, the polymer polyol utilized in the inventions of this specification have an OH number of greater than 260 mg KOH/g, such as at least 280 mg KOH/g, at least 290 mg KOH/g or at least 300 mg KOH/g. The polymer polyols may also have an OH number of no more than 1000 mg KOH/g, no more than 800 mg KOH/g, no more than 600 mg KOH/g, no more than 500 mg KOH/g or no more than 400 mg KOH/g.

The foam-forming reaction mixtures described herein may, and often do, comprise other polyols besides the foregoing polymer polyols.

In some implementations, for example, the foam-forming reaction mixture may comprise a polyether polyol, different from the polyether polyol that is the base polyol of the polymer polyol, having an OH number of 200 to 500 mg KOH/g, such as 200 to 400 mg KOH/g. 200 to 300 mg KOH/g, 200 to 250 mg KOH/g, 230 to 250 mg KOH/g or 233 to 243 mg KOH/g, and a functionality of from greater than 2 to 4, such as 2.5 to 3.5, or, in some cases, 3.0.

Such polyether polyols can be prepared, for example, by reacting suitable aliphatic divalent, trivalent and/or more valent alcohols, (e.g., ethanediol, propanediol-1,2 and propanediol-1,3, diethylene glycol, dipropylene glycol, butanediol-1,4, hexanediol-1,6, and glycerin). In some embodiments, the polyvalent alcohol starter comprises or, in some cases, consists of glycerin and the alkylene oxide comprises, or. in some cases, consists of propylene oxide.

In some implementations, the foregoing polyether polyol has an unsaturated terminal group content of less than or equal to 0.02 milliequivalents, such as from 0.005 to 0.015 milliequivalents (method used for determination ASTM D2849-69) per gram polyol, such as can be obtained by via double metal cyanide complex-catalyzed (DMC-catalyzed) polymerization of alkylene oxides, such as propylene oxides, such as is described, for example, in U.S. Pat. No. 5,158,922 (e.g., Example 30) or European Patent 654,302 (p. 5, line 26 to p. 6, line 32).

In certain implementations, such a polyether polyol is utilized in an amount of at least 30% by weight, such as 30 to 70% by weight, or 40 to 60% by weight, based on the total weight of the polyols in the foam-forming reaction mixture.

If desired, the polyol premixes of this specification may include additional compounds that contain isocyanate-reactive groups, such as chain extenders and/or crosslinking agents, and other polyether polyols and polyester polyols. Chain extenders and/or crosslinking agents include, for example, ethylene glycol, propylene glycol, butylene glycol, glycerol, diethylene glycol, dipropylene glycol, dibutylene glycol, trimethylolpropane, pentaerythritol, ethylene diamine, and diethyltoluenediamine, as well as mixtures of any two or more thereof. Polyester polyols may be prepared from, for example, an organic dicarboxylic acid having 2 to 12 carbon atoms, such as an aliphatic dicarboxylic acid having 4 to 6 carbon atoms, and a polyvalent alcohol, such as a diol or triol having 2 to 12 carbon atoms. Examples of the dicarboxylic acid are succinic acid, glutaric acid, adipic acid, suberic acid, azelaic acid, sebacic acid, decanedicarboxylic acid, maleic acid, fumaric acid, phthalic acid, isophthalic acid and terephthalic acid. Instead of a free dicarboxylic acid, a corresponding dicarboxylic acid derivative such as a dicarboxylic acid monoester or diester prepared by esterification with an alcohol having 1 to 4 carbon atoms or dicarboxylic anhydride can be used.

As indicated earlier, the foam-forming reaction mixture also comprises a blowing agent composition. Specifically, in the inventions of this specification, the blowing agent composition consists primarily of or exclusively of water. As a result, water is present in an amount of at least 80% by weight, at least 90% by weight, at least 95% by weight, at least 99% by weight, or, in some cases, 100% by weight, based on the total weight of the blowing agent composition. In some implementations, water is present in an amount of from 0.5 to 5.0% by weight, such as 2 to 5% by weight, or 4.0 to 5.0% by weight, based on the total weight of the foam-forming reaction mixture except for the weight of the polyisocyanate.

In some implementations, however, the blowing agent composition may, if desired, include a relatively low amount of physical blowing agent. Suitable physical blowing agents include hydrocarbons, such as butane, n-pentane, cyclopentane, hexane, and/or isopentane (i.e. 2-methylbutane). Other suitable physical blowing agents include halogenated blowing agents, such as CFCs, HCFCs, HFCs and/or HFOs, such as HCFOs. For example, suitable HCFOs include 1-chloro-3,3,3-trifluoropropene (HCFO-1233zd, E and/or Z isomers), 2-chloro-3,3,3-trifluoropropene (HCFO-1233xf), HCFO1223, 1,2-dichloro-1,2-difluoroethene (E and/or Z isomers), 3,3-dichloro-3-fluoropropene, 2-chloro-1,1,1,4,4,4-hexafluorobutene-2 (E and/or Z isomers). 2-chloro-1,1,1,3,4.4.4-heptafluorobutene-2 (E and/or Z isomers). In some implementations, the boiling point, at atmospheric pressure, of the HCFO is at least −25° C., at least −20° C., or, in some cases, at least −19° C., and 40° C. or less, such as 35° C. or less, or, in some cases 33° C. or less. The HCFO may have a boiling point, at atmospheric pressure, of, for example, −25° C. to 40° C., or −20° C. to 35° C., or −19° C. to 33° C.

When present at all, physical blowing is present in an amount of no more than 20% by weight, no more than 10% by weight, no more than 5% by weight, or no more than 1% by weight, based on total weight of the blowing agent composition.

The foam-forming rection mixture also comprises a catalyst. Suitable catalysts include tertiary amines, tertiary phosphines, metal chelates, acid metal salts, strong bases, various metal alcoholates and phenolates, and metal salts of organic acids. In some implementations, the catalyst includes an organotin catalyst and/or tertiary amine catalyst, which may be used singly or in some combination. For example, a combination of at least one “blowing” catalyst, which strongly promotes the reaction of an isocyanate group with a water molecule to form carbon dioxide, and either at least one “gelling” catalyst, which strongly promotes the reaction of an alcohol group with an isocyanate to form the urethane, or at least one trimerization catalyst, may be used.

Specific examples of suitable tertiary amine catalysts include: pentamethyldiethylenetriamine, N,N-dimethylcyclohexylamine, N,N′,N″-tris(3-dimethylaminopropyl-) hexahydrotriazine, tetramethylethylenediamine, tetraethylene diamine and benzyldimethylamine, and N,N′,N″-dimethylaminopropyl-hexahydrotriazine. In some implementations, tertiary amine catalyst comprises a morpholine and/or an imidazole. Suitable morpholine catalysts include, for example, dimorpholinodiethylether, dimorpholinodimethylether N-ethylmorpholine, and N-methylmorpholine. Suitable imidazole catalysts include, for example, imidazole, n-methylimidazole, and 1,2-dimethylimidazole. Specific examples of suitable organometallic catalysts include dibutyltin dilaurate, dibutyltin diacetate, stannous octoate, potassium octoate, and potassium acetate.

In some implementations, the catalyst is present in an amount of 0.01 to 3.0% by weight, or 0.3 to 2.5% by weight, based on the total weight of the foam-forming reaction mixture except for the weight of the polyisocyanate.

In some implementations, the foam-forming reaction mixture also comprises a surfactant. Any suitable surfactant can be used, including organosilicon compounds, such as polysiloxane-polyalkyene-block copolymers, such as a polyether-modified polysiloxane. Useful surfactants also include polyethylene glycol ethers of long chain alcohols, tertiary amine or alkanolamine salts of long chain alkyl acid sulfate esters, alkylsulfonic esters, or alkylarylsulfonic acids. In some cases, surfactant is utilized in an amount of 0.2 to 5.0% by weight, such as 1 to 3% by weight, based on the total weight of the polyol premix.

Additional materials which may optionally be included in the inventions of this specification include: pigments, colorants, fillers, antioxidants, flame retardants, and stabilizers. Exemplary useful flame retardants include, but are not limited to, reactive bromine based compounds and chlorinated phosphate esters, including but not limited to, tri(2-chloroethyl)phosphate (TECP), tri(1,3-dichloro-2-propyl)phosphate, tri(1-chloro-2-propyl)phosphate (TCPP) and dimethyl propyl phosphate (DMPP).

This specification is also directed to processes for producing rigid polyurethane foams. In such processes, a polyisocyanate is reacted with the polyol composition describe herein in the presence of the catalyst and blowing agent composition. In some implementations, the polyisocyanate and the polyol composition are mixed at an isocyanate index of 90 to 150, such as 120 to 150. In some implementations, the polyisocyanate and polyol are mixed at a weight ratio of polyisocyanate to polyol of at least 0.9:1, at least 1:1, 1:1 to 1.5:1 or 1.2:1 to 1.5:1.

The rigid polyurethane foams of this specification may be prepared by, for example, forming a mixture of the polyol composition with other components, such blowing agent, catalyst, and surfactant, and then mixing this in the proper ratio with the polyisocyanate. Alternatively, one or more of the components, such as the surfactant, may be combined with the polyisocyanate prior to mixing it with polyol. Other possible implementations would include adding one or more of the components as a separate stream, together with the polyol.

Many foam machines are designed to condition and mix only two components in the proper ratio. According to the two-component method (component A: polyisocyanate; and component B: polyol composition and other ingredients), the components may be mixed in the proper ratio at a temperature of 5 to 50° C., such as 15 to 35° C., injected or poured into a mold having the temperature controlled to within a range of from 20 to 70° C., such as 35 to 60° C. The mixture then expands to fill the cavity with the rigid polyurethane foam. This simplifies the metering and mixing of the reacting components which form the polyurethane foam-forming mixture, but requires that the isocyanate reactive composition be phase stable.

Alternatively, the rigid polyurethane foams may also be prepared by the so-called “quasi prepolymer” method. In this method, a portion of the polyol is reacted in the absence of the urethane-forming catalysts with the polyisocyanate in proportion so as to provide from 10 percent to 35 percent of free isocyanate groups in the reaction product based on the prepolymer. To prepare foam, the remaining portion of the polyol is added and the components are allowed to react together in the presence of the blowing agent and other appropriate additives such as the catalysts, surfactants, and water. Other additives may be added to either the isocyanate prepolymer or remaining polyol or both prior to the mixing of the components, whereby at the end of the reaction, rigid polyurethane foam is provided.

Furthermore, the rigid polyurethane foam can be prepared in a batch or continuous process by the one-shot or quasi-prepolymer methods using any well-known foaming apparatus. The rigid polyurethane foam may be produced in the form of slab stock, moldings, cavity fillings, sprayed foam, frothed foam or laminates with other materials such as hardboard, plasterboard, plastics, paper or metal as facer substrates.

The thermal conductivity of foams produced according to various implementations of the present specification is, in certain embodiments, indicates that the foams have acceptable insulating properties, i.e., the foams have a thermal conductivity measured at 35° F. (2° C.) of less than 0.150 BTU-in/h-ft²-° F. and measured at 75° F. (24° C.) of less than 0.170 BTU-in/h-ft²-° F., for foam from the core of 2-inch thick panels, as measured according to ASTM C518-15.

This specification also relates to the use of the rigid polyurethane foams described herein for thermal insulation. That is, the rigid polyurethane foams of the present specification may find use as an insulating material in refrigeration apparatuses since the combination of good thermal insulation and other properties described herein is particularly appropriate here. The rigid foams according to this specification can be used, for example, as an intermediate layer in composite elements or for filling hollow spaces of refrigerators and freezers, or refrigerated trailers. The foams may also find use in the construction industry or for thermal insulation of long-distance heating pipes and containers.

As such, the present specification also provides a composite article comprising rigid polyurethane foam as disclosed herein sandwiched between one or more facer substrates. In certain implementations, the facer substrate may be plastic (such a polypropylene resin reinforced with continuous bi-directional glass fibers or a fiberglass reinforced polyester copolymer), paper, wood, or metal. For example, in certain implementations, the composite article may be a refrigeration apparatus such as a refrigerator, freezer, or cooler with an exterior metal shell and interior plastic liner. In certain implementations, the refrigeration apparatus may be a trailer, and the composite article may include the polyurethane foams produced according to the present specification in sandwich composites for trailer floors.

The particular isocyanate-reactive compositions described herein can be particularly suitable for use in discontinuous open pour applications, such as is often used in the production of discontinuous panels or doors. As will be appreciated, in such a discontinuous process, the reaction mixture (the mixture of the isocyanate-reactive component and the isocyanate-functional component) is poured into a cavity of a mold of the desired part, in which the cavity may be lined with a facer, which can be a metal sheet, particle board, plaster board, fiber cement, or a plastic. The foam adheres to the facers as it reacts and cures. The resulting faced panel is then removed from the cavity. To be effectively used in such a process, the reaction mixture must exhibit the right level of reactivity (sufficient to allow for adequate flow of the mixture) resulting from an ideal balance of blow and gel reactivity. Furthermore, lower foaming pressures are often desirable for this process due to restrictions presented by the manufacturing equipment in addition to any potential improvements in demold performance. As a result, certain implementations of the present specification are directed to the use of the reaction mixtures described herein in such a process.

The non-limiting and non-exhaustive examples that follow are intended to further describe various non-limiting and non-exhaustive implementations without restricting the scope of the implementations described in this specification.

### EXAMPLES

### Examples 1-8

Foam-forming compositions were prepared using the following materials:
POLYOL 1: a polyether polyol having a hydroxyl number of 470 mg KOH/g and a functionality of 5.2, prepared by alkoxylating a mixture of sucrose, propylene glycol and water, in which the alkylene oxide is 100% propylene oxide;
POLYOL 2: a polyether polyol having a hydroxyl number of 388 mg KOH/g and a functionality of 4, prepared by alkoxylating o-TDA, in which the alkylene oxide is 37% by weight ethylene oxide and 63% by weight propylene oxide;
POLYOL 3: a polyether polyol having a hydroxyl number of 470 mg KOH/g and a functionality of 3.0, prepared by alkoxylating glycerin, in which the alkylene oxide is 100% propylene oxide;
POLYOL 4: a polymer polyol having an OH number of 300 mg KOH/g and a solids content of 20%, prepared by in-situ polymerization of a 48:32:20 mass ratio of styrene, acrylonitrile, and 3,3,4,4,5,5,6,6,7,7,8,8,8-tridecafluorooctyl methacrylate in a base polyol, in which the base polyol is a mixture of 3 parts by mass of POLYOL 2 to 1 part by mass of POLYOL 8;
POLYOL 5: a polymer polyol having an OH number of 295 mg KOH/g and a solids content of 20%, prepared by in-situ polymerization of a 3:2 mass ratio mixture of styrene and acrylonitrile in a base polyol, in which the base polyol is a mixture of 3 parts by mass of POLYOL 2 to 1 part by mass of POLYOL 8;
POLYOL 6: a polymer polyol having an OH number of 346 mg KOH/g and a solids content of 25%, prepared by in-situ polymerization of a 1:1 mass ratio mixture of butyl acrylate and hydroxyethyl acrylate in a base polyol, in which the base polyol has an OH number of 365 to 395 and a functionality of 3 and is a sucrose/propylene glycol/water initiated polyether polyol (100% propylene oxide epoxide block);
POLYOL 7: a polymer polyol having an OH number of 225 mg KOH/g and a solids content of 50%, prepared by in-situ polymerization of a 50:50 mass ratio mixture of styrene and acrylonitrile in a base polyol, in which the base polyol was POLYOL 3:
POLYOL 8: a polyether polyol having a hydroxyl number of 240 mg KOH/g and a functionality of 3.0, prepared by alkoxylating glycerin, in which the alkylene oxide is 100% propylene oxide;
SURFACTANT 1: a non-hydrolyzable silicone surfactant, Niax™ L-5440 from Momentive Performance Materials;
CATALYST 1: N,N,N′,N″,N″-pentamethyldiethylenetriamine;
CATALYST 2: Dimethylcyclohexylamine;
CATALYST 3:2-hydroxy-N,N,N-trimethyl-1-propylamine formate;
ADDITIVE 1: Tris(2-chloroisopropyl)phosphate;
ISOCYANATE 1: polymeric diphenylmethane diisocyanate (PMDI) prepolymer, NCO content—29.8-31.2 wt %, viscosity 235-435 mPa·s.

In each case, a master batch was prepared by mixing the polyols, catalysts, surfactant, water and additive in the amounts indicated in Table 1. Foams were prepared by mixing the masterbatch with ISOCYANATE 1 in an amount sufficient to provide the isocyanate index listed in Table 1 and pouring the mixture into an 83 ounce paper cup. The cream time, gel time, tack-free time and free rise density (“FRD”) were recorded.

Foam panels were also prepared by hand using an air-powered mixer (~3000 rpm) and utilizing a temperature controlled mold (120° F.; dimensions of 25″×13″×2″). The polyol premix and isocyanate temperatures were maintained at 25° C. and all samples were demolded after 3 minutes. Minimum fill was determined by slightly overfilling the mold cavity and then removing the excess foam such that the foam weight contained in the 25″×13″×2″ volume could be measured. After determining the minimum fill value, foam panels were prepared to obtain a desired density approximately 8-12% over the minimum fill density. Results are in Table 1.

Results are set forth in Table 1. Examples 2, 3, and 7 are inventive examples and Examples 1, 4-6 and 8 are comparative examples.

TABLE 1

| Ingredient | | 1 | 2 | 3 | 4 | 5 | 6 | 7 | 8 |
|---|---|---|---|---|---|---|---|---|---|
| POLYOL 1 | | 46.20 | — | — | — | — | — | — | — |
| POLYOL 2 | | — | — | — | 20.78 | — | — | — | — |
| POLYOL 3 | | — | — | — | — | — | — | — | 31.87 |
| POLYOL 4 | | — | — | — | — | 46.20 | — | — | — |
| POLYOL 5 | | — | 46.20 | 46.20 | — | — | — | — | — |
| POLYOL 6 | | — | — | — | — | — | 46.20 | — | — |
| POLYOL 7 | | — | — | — | — | — | — | 46.20 | — |
| POLYOL 8 | | 37.70 | 37.70 | 37.70 | 63.12 | 37.70 | 37.70 | 37.70 | 52.03 |
| SURFACTANT 1 | | 2.00 | 2.00 | 2.00 | 2.00 | 2.00 | 2.00 | 2.00 | 2.00 |
| CATALYST 1 | | 0.30 | 0.30 | 0.30 | 0.30 | 0.30 | 0.30 | 0.30 | 0.30 |
| CATALYST 2 | | 1.10 | 1.10 | 1.10 | 1.10 | 1.10 | 1.10 | 1.10 | 1.10 |
| CATALYST 3 | | 0.20 | 0.20 | 0.20 | 0.20 | 0.20 | 0.20 | 0.20 | 0.20 |
| ADDITIVE 1 | | 8.35 | 8.35 | 8.35 | 8.35 | 8.35 | 8.35 | 8.35 | 8.35 |
| Water | | 4.15 | 4.15 | 4.15 | 4.15 | 4.15 | 4.15 | 4.15 | 4.15 |
| ISOCYANATE | | 1 | 1 | 1 | 1 | 1 | 1 | 1 | 1 |
| Index | | 1.11 | 1.32 | 1.32 | 1.28 | 1.32 | 1.24 | 1.39 | 1.18 |
| Ratio | | 1.50 | 1.50 | 1.50 | 1.50 | 1.50 | 1.50 | 1.50 | 1.50 |
| Cream (s) | | 9 | 7 | 7 | 8 | —^{A} | 8 | 7 | 9 |
| Gel (s) | | 45 | 33 | 33 | 36 | — | 36 | 32 | 44 |
| Free-Rise Density (pcf) | | 1.89 | 1.86 | 1.86 | 1.77 | — | 1.78 | 1.69 | 1.85 |
| Min. Fill Density (pcf) | | 1.98 | 1.97 | 1.97 | 1.91 | — | 2.00 | 1.98 | 1.90 |
| Packed Density (pcf) | | 2.18 | 2.16 | 2.07 | 2.13 | — | 2.18 | 2.21 | 2.12 |
| Packed/Core Ratio | | 1.06 | 1.06 | 1.08 | 1.10 | — | 1.07 | 1.07 | 1.07 |
| k-Factor | 35 F. | 0.150 | 0.149 | 0.147 | 0.152 | — | 0.152 | 0.145 | 0.150 |
| | 75 F. | 0.169 | 0.168 | 0.167 | 0.173 | — | 0.173 | 0.164 | 0.171 |
| | 35/75 Ratio | 0.89 | 0.89 | 0.88 | 0.88 | — | 0.88 | 0.88 | 0.88 |
| Closed Cell Content (%) | | 85.2 | 87.2 | 88.4 | 87.6 | — | 82.4 | 88.9 | 87.8 |
| Core Density (pcf) | | 2.06 | 2.03 | 1.91 | 1.93 | — | 2.03 | 2.07 | 1.99 |
| Compressive | + | — | — | 15.6 | 19.2 | — | 24.0 | 20.3 | — |
| Strength (psi) | = | — | — | 30.1 | 34.6 | — | 40.1 | 32.5 | — |
| | =/+Ratio | — | — | 1.9 | 1.8 | — | 1.7 | 1.6 | — |
| Dimensional | 1 Day | — | — | −0.3 | 0.1 | — | 0.4 | −0.4 | −0.4 |
| Stability | @ −30° C. | | | | | | | | |
| | 7 Days | — | — | −0.2 | −2.6 | — | −1.8 | −2.0 | −0.5 |
| | @ −30° C. | | | | | | | | |
| | 1 Day @ | — | — | −3.5 | −0.3 | — | 0.8 | −1.4 | −2.5 |
| | 70° C. | | | | | | | | |
| | 7 Days @ | — | — | −3.5 | −4.1 | — | −2.1 | −4.0 | −3.4 |
| | 70° C. | | | | | | | | |

^{A}Foam completely failed and collapsed after rising to top of cup: poor/coarse cell structure

As is apparent, the foams of inventive examples 2, 3 and 7 exhibited improved thermal insulation performance, as reflected by lower k-factor, relative to the comparative examples and exhibiting other physical properties similar to the comparative examples.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1-48. (canceled)

49. A rigid polyurethane foam comprising the reaction product of a foam-forming reaction mixture comprising:
(a) a polyisocyanate;
(b) a polyol composition comprising at least 30% by weight, based on the total weight of the polyol composition, of (i) a polymer polyol having an OH number of greater than 260 mg KOH/g, wherein the polymer polyol comprises a dispersion of polymer particles in a base polyether polyol having a functionality of 2 to 6, an OH number of at least 300 mg KOH/g, and no more than 20% by weight of ethylene oxide units, based on the molecular weight of the polyether polyol, wherein the polymer particles are the reaction product of an ethylenically unsaturated composition consisting essentially of styrene and acrylonitrile;
(c) a catalyst; and
(d) a blowing agent composition comprising water in an amount of at least 80% by weight, based on the total weight of the blowing agent composition,
wherein the rigid polyurethane foam has a closed-cell content of more than 80%, measured according to ASTM D6226-15.

50. The rigid polyurethane foam of claim 49, wherein the polymer polyol having an OH number of greater than 260 mg KOH/g is present in an amount of at least 40% by weight and no more than 60% by weight, based on the total weight of the polyol composition.

51. The rigid polyurethane foam of claim 49, wherein the base polyether polyol has a functionality of 3 to 5 and an OH number of 300 to 600 mg KOH/g.

52. The rigid polyurethane foam of claim 49, wherein the base polyether polyol comprises, based on the molecular weight of the base polyol, no more than 10% by weight of ethylene oxide units.

53. The rigid polyurethane foam of claim 49, wherein the styrene and acrylonitrile are used in sufficient amounts such that the weight ratio of styrene to acrylonitrile (S:AN) is within the range of 60:40 to 50:50.

54. The rigid polyurethane foam of claim 49, wherein styrene and acrylonitrile are present in an amount of at least 90% by weight, based on the total weight of the ethylenically unsaturated composition.

55. The rigid polyurethane foam of claim 54, wherein styrene and acrylonitrile are present in an amount of at least 98% by weight, based on the total weight of the ethylenically unsaturated composition.

56. The rigid polyurethane foam of claim 49, wherein the polymer polyol has an OH number of at least 280 mg KOH/g and no more than 400 mg KOH/g.

57. The rigid polyurethane foam of claim 49, wherein the polyol composition comprises (ii) a polyether polyol, different from the base polyether polyol, having an OH number of 200 to 500 mg KOH/g and a functionality of from greater than 2 to 4, wherein polyether polyol (ii) is present in an amount of at least 30% by weight, based on the total weight of the polyol composition.

58. The rigid polyurethane foam of claim 49, wherein water is present in an amount of at least 95% by weight, based on the total weight of the blowing agent composition.

59. The rigid polyurethane foam of claim 49, wherein the polyisocyanate and the polyol composition are present in the foam-forming reaction mixture in a relative ratio, by weight, of polyisocyanate to polyol of at least 0.9:1.

60. The rigid polyurethane foam of claim 49, wherein the polyisocyanate and the polyol composition are present in the foam-forming reaction mixture in a relative ratio, by weight, of polyisocyanate to polyol of 1:1 to 1.5:1.

61. A method of making a rigid polyurethane foam having a closed-cell content of more than 80%, more than 85% or more than 88%, measured according to ASTM D6226-15, comprising reacting a polyisocyanate with a polyol composition in the presence of components comprising a catalyst and a blowing agent composition, wherein
the polyol composition comprises at least 30% by weight, based on the total weight of the polyol composition, of (i) a polymer polyol having an OH number of greater than 260 mg KOH/g, wherein the polymer polyol comprises a dispersion of polymer particles in a base polyether polyol having a functionality of 2 to 6, an OH number of at least 300 mg KOH/g, and no more than 20% by weight of ethylene oxide units, based on the molecular weight of the polyether polyol, wherein the polymer particles are the reaction product of an ethylenically unsaturated composition consisting essentially of styrene and acrylonitrile, and
the blowing agent composition comprising water in an amount of at least 80% by weight, based on the total weight of the blowing agent composition.

62. The method of claim 61, wherein the polymer polyol having an OH number of greater than 260 mg KOH/g is present in an amount of 40% by weight to 60% by weight, based on the total weight of the polyol composition.

63. The method of claim 61, wherein the base polyether polyol has a functionality of 3 to 5, an OH number of 300 to 500 mg KOH/g or 300 to 400 mg KOH/g, and comprises, based on the molecular weight of the base polyether polyol, no more than 10% by weight of ethylene oxide units.

64. The method of claim 61, wherein the styrene and acrylonitrile are used in sufficient amounts such that the weight ratio of styrene to acrylonitrile (S:AN) is 60:40 to 50:50 and styrene and acrylonitrile are present in an amount of at least 90% by weight, based on the total weight of the ethylenically unsaturated composition.

65. The method of claim 61, wherein the polymer polyol has an OH number of 280 mg KOH/g to 500 mg KOH/g.

66. The method of claim 61, wherein the polyol composition comprises (ii) a polyether polyol, different from the base polyether polyol, having an OH number of 200 to 500 mg KOH/g and a functionality of from greater than 2 to 4, wherein polyether polyol (ii) is present in an amount of at least 30% by weight, based on the total weight of the polyol composition.

67. The method of claim 61, wherein water is present in an amount of at least 90% by weight, based on the total weight of the blowing agent composition.

68. The method of claim 61, wherein the polyisocyanate and the polyol composition are present in a relative ratio, by weight, of polyisocyanate to polyol of 1:1 to 1.5:1.
